(19) United States
(12) Patent Application Publication
(10) Pub. No.: US 2026/0310488 A1
(43) Pub. Date: Oct. 8, 2026

(54) THERMAL AWARENESS EXTENSION FOR OPERATING SYSTEM TASK SCHEDULER

(71) Applicant: QUALCOMM Incorporated, San Diego, CA (US)

(72) Inventors: Azzedine Adam TOUZNI, Carlsbad, CA (US); Chandrasekhar LINGUTLA, San Diego, CA (US); Chandra BHAT, San Diego, CA (US); Anantha Ramaiah IDAPALAPATI, San Diego, CA (US); Suresh SHENOY, San Diego, CA (US); Abhijeet DHARMAPURIKAR, San Diego, CA (US); Naveed SHIRAJ, Chennai (IN); Sai Harshini NIMMALA, San Diego, CA (US)

(21) Appl. No.: 19/170,415

(22) Filed: Apr. 4, 2025

(51) Int. Cl. G06F 9/48; G06F 1/20

(52) U.S. Cl. CPC G06F 9/4818; G06F 1/206

(57) ABSTRACT

Aspects of the disclosure are directed to firmware-based thermal constraint task scheduling. In accordance with one aspect, the disclosure includes using a control firmware to generate a hint directive with an idle processor identification and a busy processor identification; sending a thermal awareness extension (TAE) interrupt request (IRQ) handler directive message upon receipt of the hint directive; scheduling a wait pattern for an idle processor and a busy processor; and executing an active load balance operation between the idle processor and the busy processor.

### TECHNICAL FIELD

This disclosure relates generally to the field of information processing systems, and, in particular, to task scheduling with thermal awareness.

### BACKGROUND

An information processing system with a plurality of processor cores and memory devices may operate in different operational modes, depending on the current service demand. Thermal management of the information processing system is an important consideration for task scheduling by an operating system (OS). An enhanced thermal awareness extension (TAE) may be desired for improving performance.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides firmware-based thermal constraint task scheduling. Accordingly, the present disclosure discloses a method including: using a control firmware to generate a hint directive with an idle processor identification and a busy processor identification; sending a thermal awareness extension (TAE) interrupt request (IRQ) handler directive message upon receipt of the hint directive; scheduling a wait pattern for an idle processor and a busy processor; and executing an active load balance operation between the idle processor and the busy processor.

Another aspect of the disclosure provides an apparatus including: a non-transitory memory configured to store one or more central processing unit (CPU) instructions; a controller firmware coupled to at least one of a plurality of processors, the controller firmware configured to generate a hint directive to schedule a wait pattern for an idle processor and a busy processor; and the plurality of processors coupled to the non-transitory memory, wherein the at least one of the plurality of processors is configured to use the one or more CPU instructions to execute an active load balance operation upon receipt of the hint directive.

Another aspect of the disclosure provides a non-transitory computer-readable medium storing computer executable code, operable on a device including at least one processor and at least one memory coupled to the at least one processor, wherein the at least one processor is configured to implement task scheduling with thermal awareness, the computer executable code including: instructions for causing a computer to use a control firmware to generate a hint directive with an idle processor identification and a busy processor identification; instructions for causing the computer to send a thermal awareness extension (TAE) interrupt request (IRQ) handler directive message upon receipt of the hint directive; instructions for causing the computer to schedule a wait pattern for an idle processor and a busy processor; and instructions for causing the computer to execute an active load balance operation between the idle processor and the busy processor.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system 100.

FIG. 2 illustrates an example firmware-based thermal constraint management architecture.

FIG. 3 illustrates an example thermal constraint management operation.

FIG. 4 illustrates an example of a first temperature trace for a software-based thermal constraint management architecture.

FIG. 5 illustrates an example of a second temperature trace for a firmware-based thermal constraint management architecture.

FIG. 6 illustrates an example processor benchmark performance summary table.

FIG. 7 illustrates an example of a processor benchmark table.

FIG. 8 illustrates an example flow diagram for implementing firmware-based thermal constraint task scheduling operation.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), uses multiple levels of coordination or synchronization. In one example, a slice may include a processing engine (i.e., a subset of the computing system) as well as associated memory units and other peripheral devices. In one example, execution of an application may be decomposed into a workload which is executed by multiple slices or multiple processing engines. A plurality of processor cores may be part of each processing engine where a processor core is an independent processing element which may be operated in parallel with other processor cores. A plurality of processing engines may be aggregated into a processor cluster which shares certain system resources (e.g., cache memory).

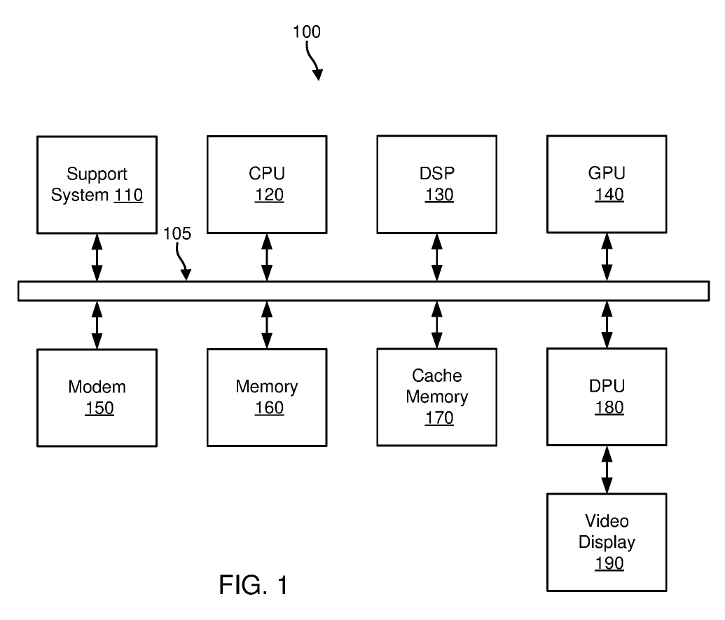

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. In one example, the CPU 120 may serve as a controller or a microcontroller of other processing engines. In one example, the controller or microcontroller may reallocate tasks from one processing engine to another. In one example, the controller or microcontroller may determine if a baseline workload partition should be reallocated using machine learning (ML) monitoring of system on a chip (SOC) temperatures.

In one example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. In one example, the memories disclosed herein may be non-transitory memory units. Although several components of the information processing system 100 are included herein, one skilled in the art would understand that the components listed herein are examples and are not exclusive. Thus, other components may be included as part of the information processing system 100 within the spirit and scope of the present disclosure.

In one example, one or more processing engines in the information processing system 100 may be aggregated into a single integrated circuit known as a system on a chip (SoC). In one example, the SoC may include the central processing unit (CPU) 120 and other processing engines such as the DSP 130 or the GPU 140. The SoC may also include the memory 160 and the cache memory 170.

In one example, the information processing system 100 may be part of a wireless device in a wireless communication system. For example, the wireless communication system may conform to a wireless network protocol such as 4G LTE (long term evolution), 5G NR (new radio), etc.

In one example, performance enhancement of a system on a chip (SoC) may be complex and challenging due to several factors. For example, the capability of processing engines has grown with incorporation of additional memory resources and integrated peripheral devices. This increased capability may be needed to support more advanced features and functionalities but adds hardware design complexity. For example, an increased quantity of processor cores with different processor core designs and separation into a plurality of processor clusters may result in increased scheduling complexity, particularly in assigning a task to an optimal processor core. For example, the operating clock frequency of processing engines has increased to allow enhanced performance (e.g., clock frequency increases of hundreds of MHz per year). For example, a higher chip package integration density may result in a package size reduction and closer transistor proximity. For example, the higher operating clock frequency may impose tighter thermal constraints on the SoC design.

One consequence of increasing SoC design complexity may be a tighter thermal constraint which forces a reduction of operating clock frequency (known as “frequency throttling”) and a reduction of SoC capability. For example, a performance benchmark which measures performance loss due to thermal constraints may show performance degradation with evolving SoC designs.

In one example, a software-based thermal constraint management architecture uses software for reactive thermal mitigation scheduling. In one example, the software-based architecture limits the operating clock frequency when a SoC temperature exceeds a temperature threshold. For example, reducing the operating clock frequency may prevent overheating but also reduces SoC performance by lowering its throughput (i.e., number of operations per second). For example, reduced SoC performance directly degrades a user experience specifically for high performance tasks.

In one example, an alternative solution for thermal constraint management involves a scheduler proactively transferring a workload from a first processor to a second processor prior to reaching the temperature threshold. However, the alternative solution faces several challenges. For example, if the scheduler lacks thermal awareness, it may not have necessary knowledge for efficient energy management. For example, the scheduler may have an inherently slow response to thermal transients. For example, for rapid thermal variations, the scheduler may be sluggish, even with thermal awareness knowledge. Consequently, the slow response may result in non-optimal SoC performance.

In one example, a firmware-based thermal constraint management architecture uses firmware for processor monitoring and proactive thermal mitigation scheduling. In one example, firmware is a low-level control logic which is tightly coupled to processor hardware. For example, low-level control logic includes hardware elements which are organized for hardware state transition management. For example, firmware has a direct communication path to processor hardware. In one example, the firmware-based architecture monitors temperatures of a plurality of processors and the SoC. The firmware then proactively requests the scheduler to initiate a workload transfer from a hot or busy processor to a colder or idle processor, thus maintaining SoC performance. In one example, the firmware-based architecture includes direct communication channel between the firmware and the scheduler. In one example, the direct communication channel is based on a standardized communication protocol (e.g., system control and management interface, SCMI).

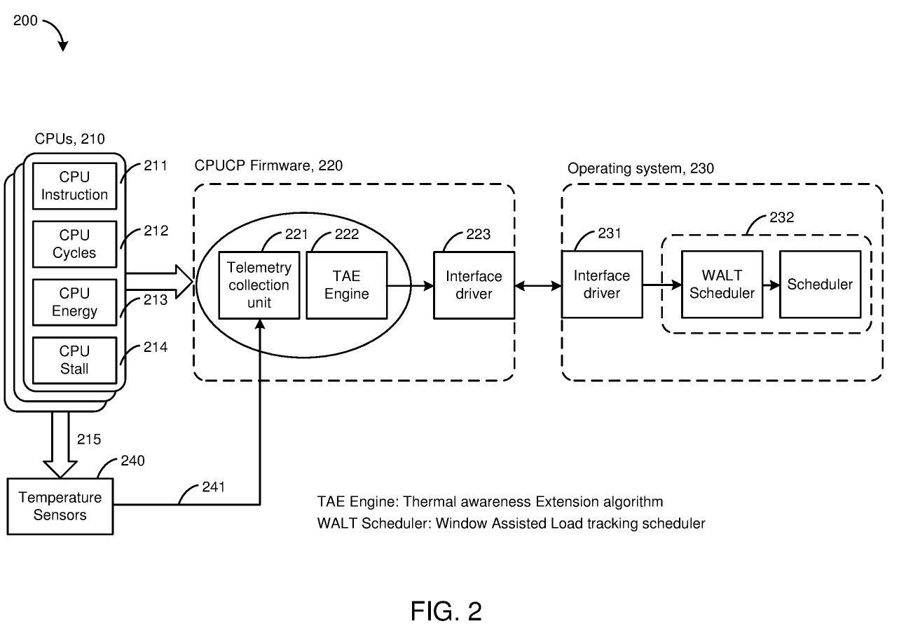

FIG. 2 illustrates an example firmware-based thermal constraint management architecture 200. In one example, the architecture 200 includes a plurality of processors 210 (e.g., CPUs), a controller firmware 220, an operating system 230 and a plurality of temperature sensors 240. In one example, the plurality of processors 210 includes a CPU instruction monitor 211, a CPU cycle monitor 212, a CPU energy usage monitor 213 and a CPU stall counter 214. In one example, the plurality of processors 210 provides a plurality of temperature data 215 which is measured by the plurality of temperature sensors 240 to produce a plurality of sensed temperature data 241.

In one example, the controller firmware 220 includes a telemetry collection unit 221, a thermal awareness extension (TAE) engine 222 and a first interface driver 223. In one example, the telemetry collection unit 221 receives the plurality of sensed temperature data 241 from the plurality of temperature sensors 240. In one example, the controller firmware 220 is low-level control logic for hardware device management which is stored in non-volatile memory. In one example, the controller firmware 220 is low-level control logic which is tightly coupled to the plurality of processors 210. For example, firmware has a direct communication path to the plurality of processors 210.

In one example, the operating system 230 includes a second interface driver 231 and a scheduler 232. In one example, the operating system 230 is software used for overall system management. In one example, the scheduler 232 includes a load tracking scheduler and a core scheduler. In one example, the second interface driver 231 receives a firmware directive 224 from the first interface driver 223 in the controller firmware 220. In one example, the firmware directive 224 includes a hint directive for the scheduler 232. In one example, the scheduler 232 composes of two schedulers, wherein the WALT scheduler is a load tracking scheduler and the other scheduler is a non-load tracking scheduler. For example, the hint directive triggers an active load balance operation among the plurality of processors 210.

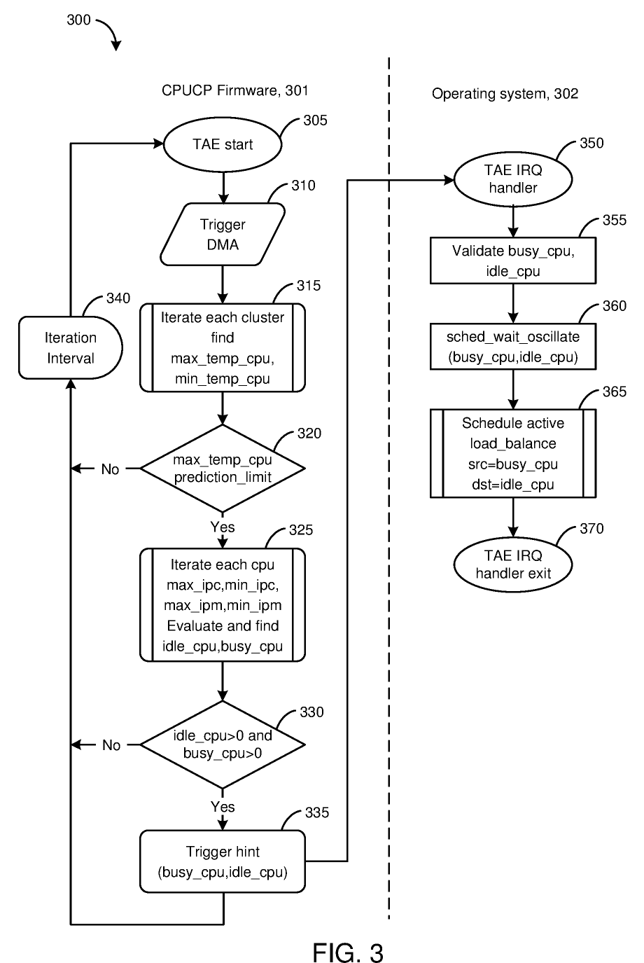

FIG. 3 illustrates an example thermal constraint management operation 300. In one example, the operation 300 includes a firmware operation portion 301 and an operating system operation portion 302. In one example, the firmware operation portion 301 executes firmware code. In one example, the operating system operation portion 302 executes software code. In one example, firmware code is non-reprogrammable after system fielding. In one example, software code is reprogrammable after system fielding.

In one example, the firmware operation portion 301 commences with a thermal awareness engine (TAE) start in block 305 with an initial iteration interval counter value. In block 310, the firmware operation portion 301 triggers a direct memory access (DMA) for retrieval of the plurality of sensed temperature data. In block 315, the firmware operation portion 301 determines a maximum cluster temperature and a minimum cluster temperature for each processor cluster (i.e., group of processors). In block 320, the firmware operation portion 301 compares the maximum cluster temperature to a temperature prediction limit. If the maximum cluster temperature exceeds the temperature prediction limit, proceed to block 325. In the maximum cluster temperature does not exceed the temperature prediction limit, proceed to block 340. In one example, the maximum cluster temperature is the maximum temperature of all processors in that cluster.

In block 325, the firmware operation portion 301 determines processor performance metrics for each processor. In one example, the processor performance metrics include a maximum instructions per cycle (max_IPC), a minimum instructions per cycle (min_IPC), a maximum instructions per cache miss (max_IPM) and a minimum instructions per cache miss (min_IPM). In one example, the processor performance metrics also includes identifying an idle processor and identifying a busy processor. In one example, the idle processor is a least utilized processor (e.g., coldest processor) and the busy processor is a most utilized processor (e.g., hottest processor).

In block 330, the firmware operation portion 301 assesses if both the idle processor and the busy processor are identified. If true, proceed to block 335. If the either or both the idle processor or the busy processor are not identified, proceed to block 340.

In block 335, the firmware operation portion 301 generates a hint directive with the idle processor and busy processor identification. In one example, the hint directive is sent to the operating system operation portion 302 in block 350. In one example, the hint directive is sent using a direct communication channel between the firmware operation portion 301 and the operating system operation portion 302. In one example, the direct communication channel is based on a standardized communication protocol (e.g., system control and management interface, SCMI). In one example, the firmware operation 301 proceeds to block 340.

In block 340, the firmware operation portion 301 increments the iteration interval counter value and returns to block 305. In one example, the iteration interval counter value increment corresponds to sub-millisecond resolution. In one example, the hint directive may be overruled by a higher priority directive subject to operating system constraints. includes a direct communication channel.

In one example, the operating system operation portion 302 commences with a TAE interrupt request (IRQ) handler directive message upon receipt of the hint directive in block 350. In block 355, the operating system operation portion 302 validates the idle processor and busy processor identification.

In block 360, the operating system operation schedules a wait pattern for the idle processor and the busy processor. In one example, the wait pattern verifies that both the idle processor and the busy processor are in the same cluster and that the current task may be moved from the busy processor.

In block 365, the operating system operation executes an active load balance operation between the idle processor and the busy processor. In one example, the busy processor is a source processor and the idle processor is a destination processor for the active load balance operation. In block 370, the operating system operation issues a TAE interrupt request (IRQ) handler exit message to complete the active load balance operation.

In one example, the firmware operation portion 301 operates at a very granular time intervals (e.g., < 1 ms intervals or sub-millisecond resolution). In one example the firmware operation portion 301 monitors SoC temperatures and performance metrics such as CPU instructions, CPU cycles, CPU energy usage and CPU stall counters to monitor SoC conditions and performance. In one example, if an imbalance is detected between processors in one processor cluster, then the firmware operation portion 301 proactively provides a hint directive to the operating system operation portion 302.

In one example, the active load balancing operation is used to distribute a plurality of workloads across a plurality of processing engines to enhance resource utilization, maximize throughput, minimize response time and minimize overloading of any single processing engine. In one example, when the TAE triggers a hint directive, the scheduler evaluates current system conditions and invokes the active load balancing operation to transfer a current running task from a source processor (i.e., busy processor) to a destination processor (i.e., idle processor). In one example, the active load balancing operation pauses a current running task and transfers it to the idle processor before resuming the current running task.

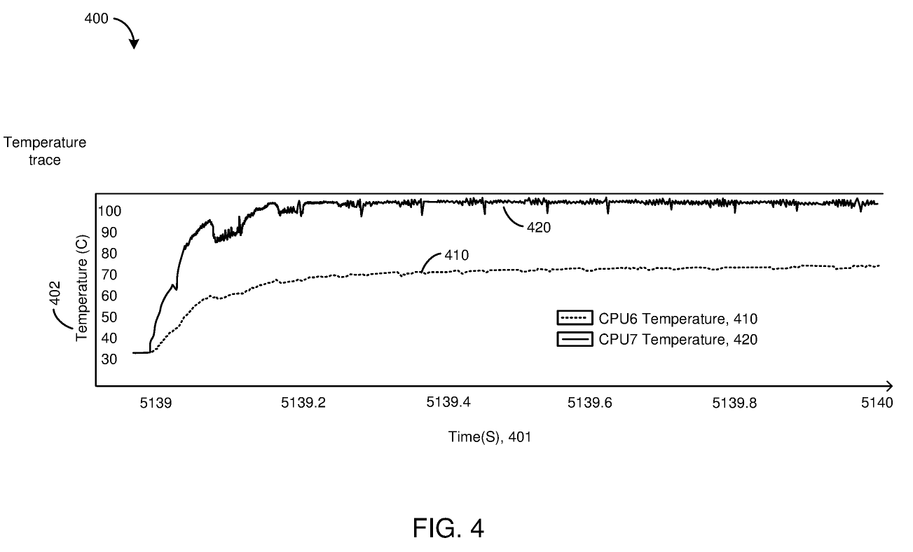

FIG. 4 illustrates an example of a first temperature trace 400 for a software-based thermal constraint management architecture. In one example, the first temperature trace 400 includes a time axis 401 in seconds on a horizontal axis and a temperature axis 402 in degrees Celsius on a vertical axis. In one example, the first temperature trace 400 includes an idle processor temperature graph 410 and a busy processor temperature graph 420. In one example, the busy processor temperature graph 420 shows an increasingly hotter thermal profile while the busy processor is operational and the idle processor temperature graph 430 shows a colder thermal profile while the idle processor remains non-operational without an active load balancing operation (i.e., with TAE disabled).

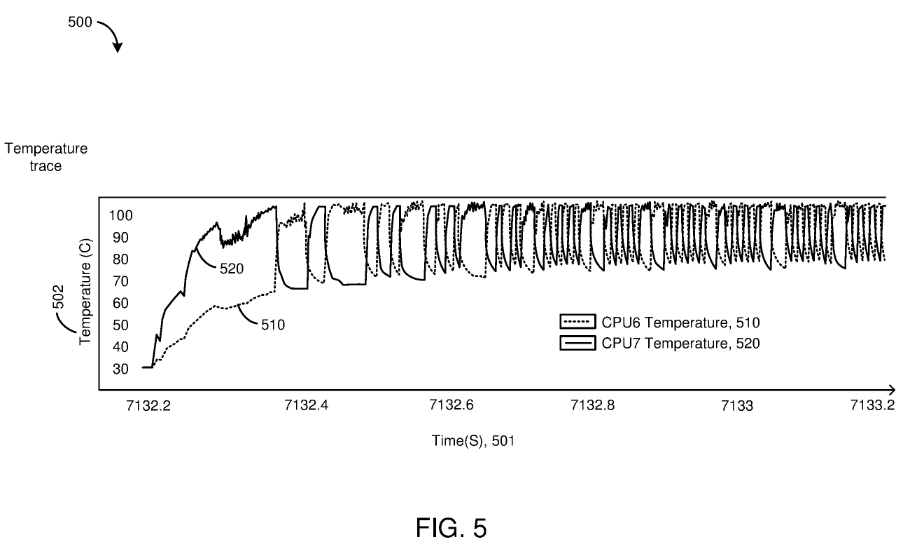

FIG. 5 illustrates an example of a second temperature trace 500 for a firmware-based thermal constraint management architecture. In one example, the second temperature trace 500 includes a time axis 501 in seconds on a horizontal axis and a temperature axis 502 in degrees Celsius on a vertical axis. In one example, the second temperature trace 500 includes an idle processor temperature graph 510 and a busy processor temperature graph 520. In one example, the busy processor temperature graph 520 shows a first mitigated thermal profile while the busy processor is operational and the idle processor temperature graph 530 shows a second mitigated thermal profile while the idle processor shares a workload according to an active load balancing operation (i.e., with TAE enabled).

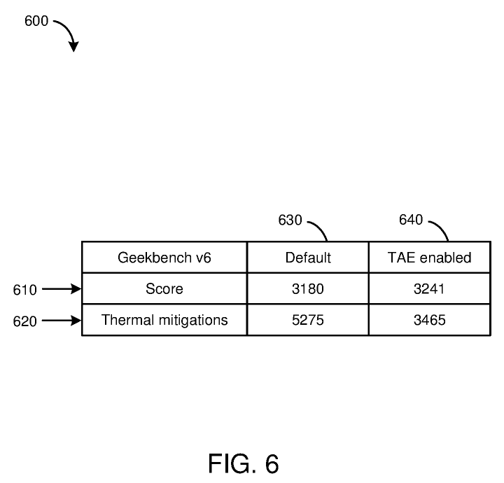

FIG. 6 illustrates an example processor benchmark performance summary table 600. In one example, the performance summary table 600 includes a performance score row 610 and a thermal mitigation score row 620 for two scenarios: a default (without active load balancing) scenario 630 and a TAE-enabled (i.e., with active load balancing) scenario 640. In one example, the performance score row 610 tabulates benchmark quantitative performance on a monotonic scale which increases with improved processor performance (e.g., throughput). In one example, thermal mitigation score row 620 tabulates benchmark thermal performance on a monotonic scale which increases with greater thermal stress (e.g., hotter temperature). In one example, the performance summary table 600 shows that thermal stress is reduced approximately 30% while the processor performance improves approximately 1% when TAE is enabled (i.e., with active load balancing).

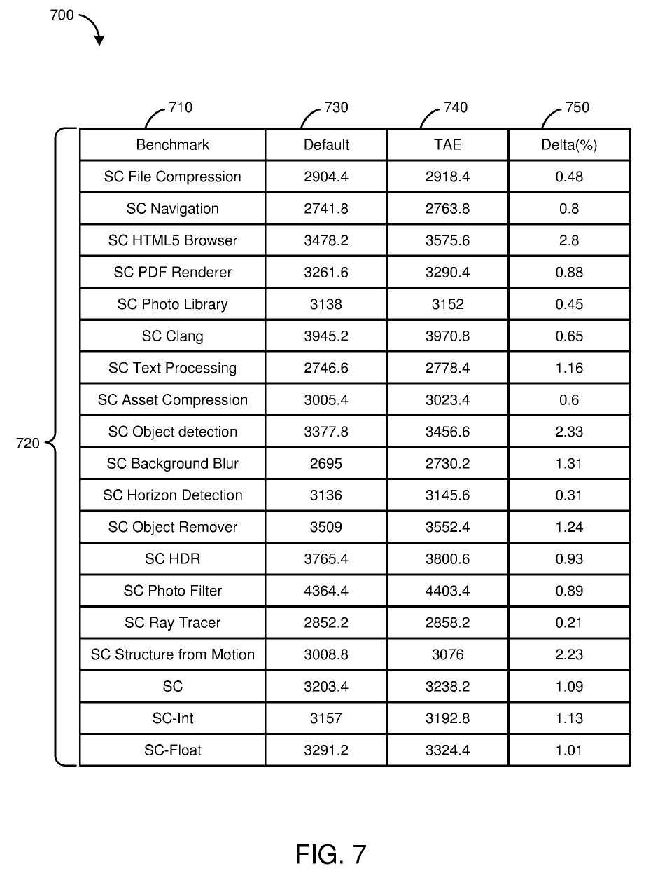

FIG. 7 illustrates an example of a processor benchmark table 700. In one example, the processor benchmark table 700 includes a benchmark column 710 with a plurality of performance benchmarks 720, a default (without active load balancing) scenario column 730, a TAE-enabled (i.e., with active load balancing) scenario column 740 and a delta performance column 750. In one example, the processor benchmark table 700 shows that processor performance improves noticeably when switching from the default scenario (without active load balancing) and the TAE-enabled scenario (with active load balancing). In one example, the usage of firmware-based active load balancing mitigates processor thermal stress.

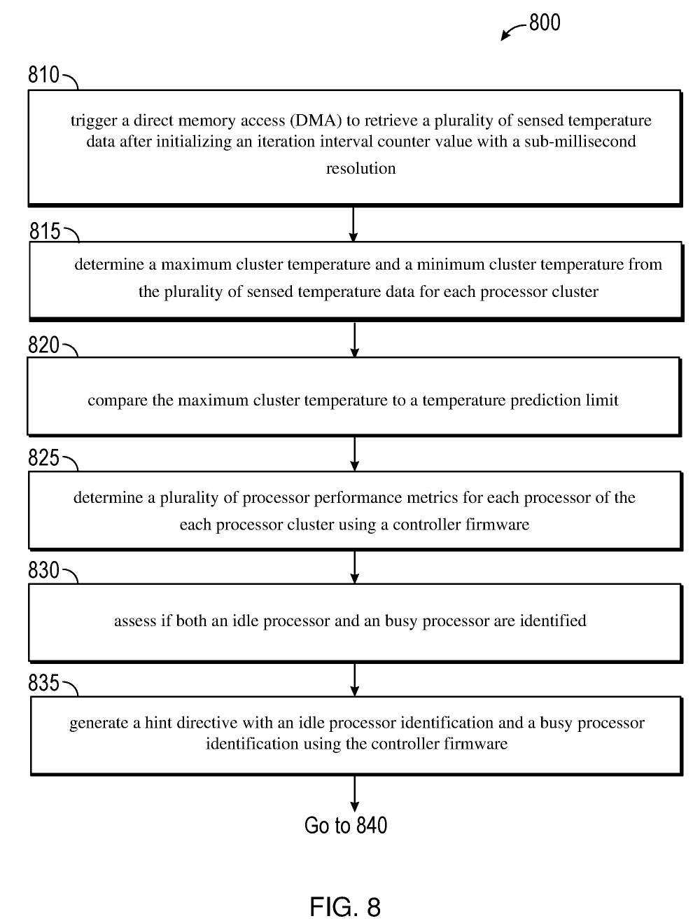

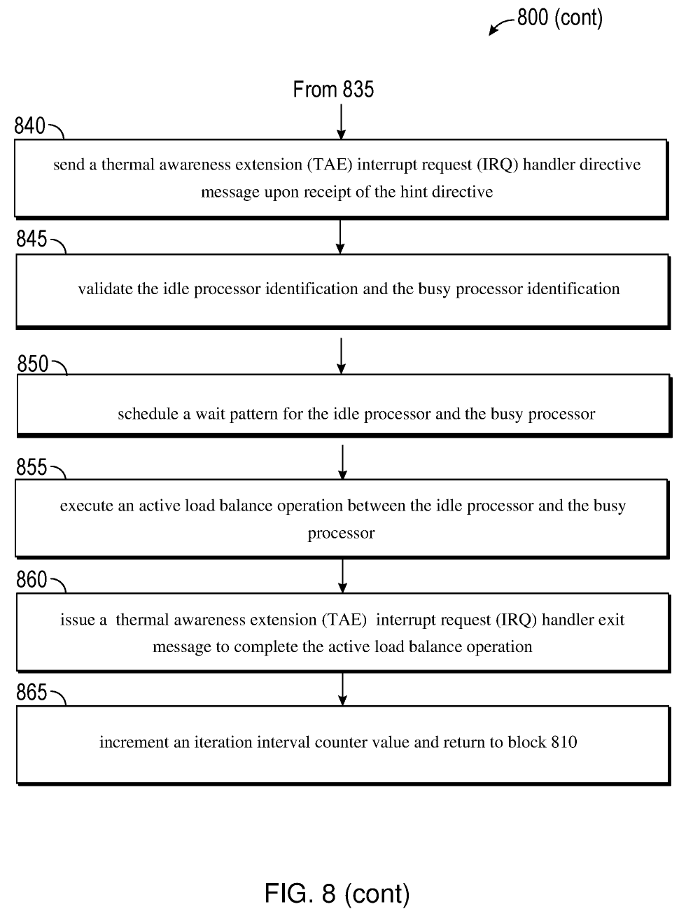

FIG. 8 illustrates an example flow diagram 800 for implementing firmware-based thermal constraint task scheduling operation. In block 810, trigger a direct memory access (DMA) to retrieve a plurality of sensed temperature data after initializing an iteration interval counter value with a sub-millisecond resolution. In one example, a direct memory access (DMA) is triggered to retrieve a plurality of sensed temperature data after initializing an iteration interval counter value with a sub-millisecond resolution.

In one example, the sub-millisecond resolution corresponds to a time granularity of less than one millisecond (1 ms). In one example, the sensed temperature data is a plurality of cluster temperatures. In one example, the sensed temperature data is a plurality of processor temperatures. In one example, the sensed temperature data is stored in L1 cache memory or L2 cache memory. In one example, the DMA is executed by a controller firmware. In one example, the DMA is executed by a SoC.

In block 815, determine a maximum cluster temperature and a minimum cluster temperature from the plurality of sensed temperature data for each processor cluster. In one example, a maximum cluster temperature and a minimum cluster temperature are determined from the plurality of sensed temperature data for each processor cluster. In one example, the maximum cluster temperature is associated with a busy processor and the minimum cluster temperature is associated with an idle processor. In one example, the determination is performed by the controller firmware. In one example, the determination is performed by the SoC.

In block 820, compare the maximum cluster temperature to a temperature prediction limit. In one example, the maximum cluster temperature is compared to a temperature prediction limit. If the maximum cluster temperature is greater than the temperature prediction limit, proceed to block 825. If the maximum cluster temperature is not greater than the temperature prediction limit, proceed to block 865. In one example, the temperature prediction limit establishes a threshold for thermal awareness extension (TAE). In one example, the comparison is performed by the controller firmware. In one example, the comparison is performed by the SoC.

In block 825, determine a plurality of processor performance metrics for each processor of the each processor cluster using a controller firmware. In one example, a plurality of processor performance metrics is determined for each processor of the each processor cluster using a controller firmware. In one example, the plurality of processor performance metrics includes a maximum instructions per cycle (max_IPC), a minimum instructions per cycle (min_IPC), a maximum instructions per cache miss (max_IPM) and a minimum instructions per cache miss (min_IPM). In one example, the processor performance metrics also includes identifying an idle processor and identifying a busy processor. In one example, the idle processor is a least utilized processor (e.g., coldest processor) and the busy processor is a most utilized processor (e.g., hottest processor). In one example, the determination is performed by the controller firmware. In one example, the determination is performed by the SoC.

In block 830, assess if both an idle processor and an busy processor are identified. In one example, the idle processor and/or the busy processor are from processor clusters. If true, proceed to block 835. If either or both the idle processor or the busy processor are not identified, proceed to block 865. In one example, the assessment is performed by the controller firmware. In one example, the comparison is performed by the SoC.

In block 835, generate a hint directive with an idle processor identification and a busy processor identification using the controller firmware. In one example, a hint directive is generated with an idle processor identification and a busy processor identification using the controller firmware.

In one example, the generation is followed by block 840. In one example, the hint directive is sent to a scheduler. In one example, the hint directive is sent using a direct communication channel between the controller firmware and the scheduler. In one example, the direct communication channel is based on a standardized communication protocol (e.g., system control and management interface, SCMI). In one example, the hint directive may be overruled by a higher priority directive subject to operating system constraints. In one example, the generation is followed by block 865. In one example, the generation is performed by the controller firmware. In one example, the generation is performed by the SoC.

In block 840, send a thermal awareness extension (TAE) interrupt request (IRQ) handler directive message upon receipt of the hint directive. In one example, a thermal awareness extension (TAE) interrupt request (IRQ) handler directive message is sent upon receipt of the hint directive. In one example, the TAE IRQ handler directive message halts a currently running task. In one example, the sending is performed by an operating system software. In one example, the sending is performed by the SoC.

In block 845, validate the idle processor identification and the busy processor identification. In one example, the idle processor identification and the busy processor identification are validated. In one example, the validation is performed by the operating system software. In one example, the validation is performed by the SoC.

In block 850, schedule a wait pattern for the idle processor and the busy processor. In one example, a wait pattern is scheduled for the idle processor and the busy processor. In one example, the scheduling is performed by the operating system software. In one example, the scheduling is performed by the SoC.

In block 855, execute an active load balance operation between the idle processor and the busy processor. In one example, an active load balance operation is executed between the idle processor and the busy processor. In one example, the busy processor is a source processor and the idle processor is a destination processor for the active load balance operation. In one example, the execution is performed by the operating system software. In one example, the execution is performed by the SoC.

In block 860, issue a thermal awareness extension (TAE) interrupt request (IRQ) handler exit message to complete the active load balance operation. In one example, a thermal awareness extension (TAE) interrupt request (IRQ) handler exit message is issued to complete the active load balance operation. In one example, the active load balancing operation pauses a current running task and transfers it to the idle processor before resuming the current running task. In one example, the issuing is performed by the operating system software. In one example, the issuing is performed by the SoC.

In block 865, increment an iteration interval counter value and then return to block 810. In one example, an iteration interval counter value is incremented and then return to block 810. In one example, the iteration interval counter value increment corresponds to sub-millisecond resolution. In one example, the incrementing is performed by the controller firmware. In one example, the incrementing is performed by the SoC.

In one example, in the steps of FIG. 8, SoC may include one or more of the following: a non-transitory memory, a microprocessor, a microcontroller, a central processing unit (CPU), a graphics processing unit (GPU, a display processing unit (DPU), etc.

In one example, the present disclosure includes a method including: using a control firmware to generate a hint directive with an idle processor identification and a busy processor identification; sending a thermal awareness extension (TAE) interrupt request (IRQ) handler directive message upon receipt of the hint directive; scheduling a wait pattern for an idle processor and a busy processor; and executing an active load balance operation between the idle processor and the busy processor.

In one example, the TAE IRQ handler directive message halts a currently running task. In one example, the method further includes sending the hint directive to a scheduler. In one example, the method further includes using a direct communication channel between the controller firmware and the scheduler for sending the hint directive. In one example, the direct communication channel is based on a standardized communication protocol.

In one example, the method further includes validating the idle processor identification and the busy processor identification. In one example, the method further includes issuing a thermal awareness extension (TAE) interrupt request (IRQ) handler exit message to complete the active load balance operation. In one example, the busy processor is a source processor and the idle processor is a destination processor.

In one example, the method further includes pausing a current running task and transfers the current running task to the idle processor before resuming the current running task. In one example, the method further includes incrementing an iteration interval counter value. In one example, the method further includes assessing if both the idle processor and the busy processor are identified.

In one example, the method further includes determining a plurality of processor performance metrics for each processor of each processor cluster using the controller firmware. In one example, the method further includes determining a maximum cluster temperature and a minimum cluster temperature from a plurality of sensed temperature data for the each processor cluster. In one example, the method further includes comparing the maximum cluster temperature to a temperature prediction limit.

In one example, the method further includes initializing the iteration interval counter value with a sub-millisecond resolution; and triggering a direct memory access (DMA) to retrieve the plurality of sensed temperature data after the initializing.

In one example, the present disclosure includes an apparatus including: a non-transitory memory configured to store one or more central processing unit (CPU) instructions; a controller firmware coupled to at least one of a plurality of processors, the controller firmware configured to generate a hint directive to schedule a wait pattern for an idle processor and a busy processor; and the plurality of processors coupled to the non-transitory memory, wherein the at least one of the plurality of processors is configured to use the one or more CPU instructions to execute an active load balance operation upon receipt of the hint directive.

In one example, the apparatus further includes a plurality of temperature sensors coupled to the controller firmware and the plurality of processors, the plurality of temperature sensors configured to generate a plurality of sensed temperature data. In one example, the controller firmware is further configured to use the plurality of sensed temperature data to determine a maximum cluster temperature. In one example, the controller firmware is further configured to determine a plurality of processor performance metrics for one or more of the plurality of processors.

In one example, the present disclosure includes a non-transitory computer-readable medium storing computer executable code, operable on a device including at least one processor and at least one memory coupled to the at least one processor, wherein the at least one processor is configured to implement task scheduling with thermal awareness, the computer executable code including: instructions for causing a computer to use a control firmware to generate a hint directive with an idle processor identification and a busy processor identification; instructions for causing the computer to send a thermal awareness extension (TAE) interrupt request (IRQ) handler directive message upon receipt of the hint directive; instructions for causing the computer to schedule a wait pattern for an idle processor and a busy processor; and instructions for causing the computer to execute an active load balance operation between the idle processor and the busy processor.

In one aspect, one or more of the steps for providing firmware-based thermal constraint task scheduling in FIG. 8 may be executed by one or more processors which may include hardware, software, firmware, etc. The one or more processors, for example, may be used to execute software or firmware needed to perform the steps in the flow diagram of FIG. 8. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method comprising:
using a control firmware to generate a hint directive with an idle processor identification and a busy processor identification;
sending a thermal awareness extension (TAE) interrupt request (IRQ) handler directive message upon receipt of the hint directive;
scheduling a wait pattern for an idle processor and a busy processor; and
executing an active load balance operation between the idle processor and the busy processor.

2. The method of claim 1, wherein the TAE IRQ handler directive message halts a currently running task.

3. The method of claim 1, further comprising sending the hint directive to a scheduler.

4. The method of claim 3, further comprising using a direct communication channel between the controller firmware and the scheduler for sending the hint directive.

5. The method of claim 4, wherein the direct communication channel is based on a standardized communication protocol.

6. The method of claim 1, further comprising validating the idle processor identification and the busy processor identification.

7. The method of claim 6, further comprising issuing a thermal awareness extension (TAE) interrupt request (IRQ) handler exit message to complete the active load balance operation.

8. The method of claim 7, wherein the busy processor is a source processor and the idle processor is a destination processor.

9. The method of claim 7, further comprising pausing a current running task and transfers the current running task to the idle processor before resuming the current running task.

10. The method of claim 7, further comprising incrementing an iteration interval counter value.

11. The method of claim 10, further comprising assessing if both the idle processor and the busy processor are identified.

12. The method of claim 11, further comprising determining a plurality of processor performance metrics for each processor of each processor cluster using the controller firmware.

13. The method of claim 12, further comprising determining a maximum cluster temperature and a minimum cluster temperature from a plurality of sensed temperature data for the each processor cluster.

14. The method of claim 13, further comprising comparing the maximum cluster temperature to a temperature prediction limit.

15. The method of claim 14, further comprising:
initializing the iteration interval counter value with a sub-millisecond resolution; and
triggering a direct memory access (DMA) to retrieve the plurality of sensed temperature data after the initializing.

16. An apparatus comprising:
a non-transitory memory configured to store one or more central processing unit (CPU) instructions;
a controller firmware coupled to at least one of a plurality of processors, the controller firmware configured to generate a hint directive to schedule a wait pattern for an idle processor and a busy processor; and
the plurality of processors coupled to the non-transitory memory, wherein the at least one of the plurality of processors is configured to use the one or more CPU instructions to execute an active load balance operation upon receipt of the hint directive.

17. The apparatus of claim 16, further comprising a plurality of temperature sensors coupled to the controller firmware and the plurality of processors, the plurality of temperature sensors configured to generate a plurality of sensed temperature data.

18. The apparatus of claim 17, wherein the controller firmware is further configured to use the plurality of sensed temperature data to determine a maximum cluster temperature.

19. The apparatus of claim 16, wherein the controller firmware is further configured to determine a plurality of processor performance metrics for one or more of the plurality of processors.

20. A non-transitory computer-readable medium storing computer executable code, operable on a device comprising at least one processor and at least one memory coupled to the at least one processor, wherein the at least one processor is configured to implement task scheduling with thermal awareness, the computer executable code comprising:
instructions for causing a computer to use a control firmware to generate a hint directive with an idle processor identification and a busy processor identification;
instructions for causing the computer to send a thermal awareness extension (TAE) interrupt request (IRQ) handler directive message upon receipt of the hint directive;
instructions for causing the computer to schedule a wait pattern for an idle processor and a busy processor; and
instructions for causing the computer to execute an active load balance operation between the idle processor and the busy processor.
